(19) United States
(12) Patent Application Publication
(10) Pub. No.: US 2007/0125274 A1
(43) Pub. Date: Jun. 7, 2007

(54) THERMALLY CONDUCTIVE GROUT FOR GEOTHERMAL HEAT PUMP SYSTEMS

(75) Inventor: James D. Miller, Roswell, GA (US)

Correspondence Address: BARLOW, JOSEPHS & HOLMES, LTD., 101 DYER STREET, 5TH FLOOR, PROVIDENCE, RI, 02903, US

(73) Assignee: COOL OPTIONS, INC., Warwick, RI (US)

(21) Appl. No.: 11/565,295

(22) Filed: Nov. 30, 2006

Related U.S. Application Data
(60) Provisional application No. 60/741,570, filed on Dec. 2, 2005.

(51) Int. Cl. C04B 28/00; C04B 14/00

(52) U.S. Cl. 106/638; 106/814

(57) ABSTRACT

A thermally conductive grout for geothermal heat pump systems is disclosed. Preferably, the grout includes graphite and/or natural graphite as a thermally conductive additive in a cementitious base to achieve a composition having a thermal conductivity greater than 4 W/mK.

### CROSS-REFERENCE TO RELATED APPLICATION

This application claims priority to earlier filed U.S. Provisional Patent Application Ser. No. 60/741,570, filed Dec. 1, 2005, the contents of which are incorporated herein by reference.

### BACKGROUND OF THE INVENTION

1 . Field of the Invention

The present invention is related to geothermal heat pump systems and in particular a grout for increasing the thermal conductivity of such systems

2 . Background of the Related Art

Geothermal heat pump (GHP) systems are the most energy-efficient, environmentally clean, and cost-effective space conditioning systems available.

GHP systems can reduce energy consumption—and corresponding emissions—by over 40% compared to air source heat pumps and by over 70% compared to electric resistance heating with standard air-conditioning equipment.

GHP systems use the Earth's energy storage capability to heat and cool buildings, and to provide hot water. The earth is a huge energy storage device that absorbs and stores the sun's heat energy. A GHP system takes this heat during the heating season, and returns it during the cooling season. GHP systems use conventional vapor compression heat pumps to extract the low-grade solar energy from the earth. In summer, the process reverses and the earth becomes a heat sink.

GHP system designs include closed loop systems which use horizontal or vertical heat exchangers made of heat-fused high density polyethylene pipe.

These systems usually circulate water with biodegradable antifreeze added.

Open loop systems generally draw ground water through the heat pump, and return it to the ground unaltered except for a small temperature change.

GHP systems are a renewable resource. In heating mode, an efficient GHP system will move at least three units of solar energy from the ground for each unit of electricity used by the heat pump and its accessories. In cooling mode, the same heat exchanger rejects heat to the surrounding ground, which equilibrates with the atmosphere. The energy flux attributable to the heat pumps is orders of magnitude lower than the solar energy received at the ground.

GHP systems, however, are only as efficient as they are capable of transferring heat to and from the earth. Therefore, there is a need to maximize the thermal conductivity of the GHP systems to increase the energy efficiency thereof.

### SUMMARY OF THE INVENTION

The present invention solves the problem of the prior art by providing a thermally conductive grout mixture that can augment the heat interchange between geothermal heat pump (“GHP”) systems and the earth. A grout mixture containing a thermally conductive additive, such as graphite and natural graphite, exhibits increased thermal conductivity and can achieve desirable thermal conductivities greater than 4 W/mK. Preferably a cementitious base is loaded with between about 2 and about 25 percent by weight of a thermally conductive additive to achieve the desired thermal conductivity. If graphite or natural graphite is used as an additive, particle sizes from about 10 to about 1000 micrometers can be used.

Accordingly, among the objects of the present invention is the provision for a thermally conductive grout mixture that includes a thermally conductive additive.

Also among the objects of the present invention is the provision for a thermally conductive grout mixture that exhibits thermal conductivity greater then 4 W/mK.

Another object of the present invention is the provision for a thermally conductive grout mixture that uses graphite and/or natural graphite as a thermally conductive additive.

Another object of the present invention is the provision for a thermally conductive grout mixture that has increased barrier strength.

### DETAILED DESCRIPTION OF THE PREFERRED EMBODIMENTS

Typical grout mixtures are composed of bentonite, bentonite/sand, cementitious and other materials for use in geothermal heat pump (“GHP”) systems. The addition of a graphite additive of the present invention increases the thermal conductivity of the grout mixture. In general reasonably small amounts of graphite translate to large increases in thermal conductivity. Preferably, the grout mixture contains from 2 to 25, but more preferably 5 to 15, percent by weight of the graphite additive. Furthermore, graphite from 10 to 1000 μm, but more preferably 200 to 500 μm, particle size range is preferred. The particles can be uniform in size or a mixture of particle sizes falling within the desired ranges. Natural graphite is preferred since their origin is from the earth and the composition of any contaminants is natural (from the earth). Natural graphite is also preferred since extracts from synthetic graphite compositions can include small quantities of organics that might be undesirable as a grout component if it leaches into the surrounding soil or water.

In addition to the increase in thermal conductivity, graphite additives improve other performance characteristics of grouts for GHP systems. These include but are not limited to the coefficient of permeability, infiltration rate, shrinkage and expansion control as a function of temperature and moisture content, bonding characteristics to the down hold tube, crack resistance, flow or viscosity characteristics. Additional additives can assist in the retention of properties during use including polymers that control the moisture content, increase adhesion, and increase crack resistance.

Increased thermal conductivity improves the efficiency of GHP systems by reducing the thermal resistance between the ground (heat sink or heat source) and the heat transfer fluid pumped typically through a u-tube placed in a ground hole. Efficiency of the heat transfer reduces depth of drilling required and the overall efficiency (and therefore cost) of the system.

The thermal conductivity of grouts for GHP systems was historically 1.5 W/mK. Improvements have raised the thermal conductivity to a higher level. Conductivity as high as 2.4 W/mK has been reported (ref. 1 and 2). These are the highest reported values. Adding natural graphite of grout mixtures raises the thermal conductivity appreciably. Historically, sand has been used as a high conductivity additive to grouts for hydrothermal heat pump systems. The conductivity of sand (mostly silica) is about 2.4 W/mK. Thermal conductivity approaching 4 W/mK is highly desirable to further increase the efficiency of the system. Natural graphite has a thermal conductivity of 400-1000 W/mK in the ab plane and a thermal conductivity of about 15 W/mK in the c plane. In a grout material that is pumped or poured into a ground hole there is significant averaging of the orientation of the graphite particles, and therefore an averaging of the effect of the anisotropy of the graphite particle as it effects the overall thermal conductivity of the grout. Percentage additions of the graphite to the grout have a tremendous effect on the conductivity, achieving the 4 W/mK goal and above at quite low concentrations.

In addition, the grout also acts as a barrier between the system and the surrounding ground water. Grouts of this invention increase the barrier strength by reducing the permeability through the grout. The graphite additive accomplishes this through its chemical nature which is inert and provides low diffusion rates/low permeability. The graphite additive also accomplishes this through its particle size which provides a tortuous path for any substance attempting to permeate the barrier.

Therefore, it can be seen that the present invention provides a unique solution to the problems of the prior art by providing a grout composition including a graphite additive to increase the thermal conductivity thereof.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A thermally conductive grout for geothermal heat pump systems, comprising:
a cementitious base; and
a thermally conductive additive.

2. The grout of claim 1, wherein said thermally conductive additive is graphite.

3. The grout of claim 2, wherein said thermally conductive additive is natural graphite.

4. The grout of claim 2, wherein said graphite has particles ranging in size from about 10 to about 1000 micrometers.

5. The grout of claim 3, wherein said graphite has particles ranging in size from about 10 to about 1000 micrometers.

6. The grout of claim 2, wherein said graphite has particles ranging in size from about 200 to about 500 micrometers.

7. The grout of claim 3, wherein said graphite has particles ranging in size from about 200 to about 500 micrometers.

8. The grout of claim 1, wherein said thermally conductive additive comprises from about 2 to about 25 percent by weight.

9. The grout of claim 8, wherein said thermally conductive additive comprises from about 5 to about 15 percent by weight.

10. The grout of claim 1, wherein said grout has a thermal conductivity of greater than 4 W/mK.

11. A thermally conductive grout for geothermal heat pump systems, comprising:
a cementitious base; and
a graphite additive of about 2 to about 25 percent by weight.

12. The grout of claim 11, wherein said thermally conductive additive is natural graphite.

13. The grout of claim 11, wherein said graphite has particles ranging in size from about 10 to about 1000 micrometers.

14. The grout of claim 13, wherein said graphite has particles ranging in size from about 200 to about 500 micrometers.

15. The grout of claim 11, wherein said grout has a thermal conductivity of greater than 4 W/mK.

16. A thermally conductive grout for geothermal heat pump systems, comprising:
a cementitious base; and
a natural graphite additive of about 5 to about 15 percent by weight, having particles ranging in size from about 200 to about 500 micrometers;
whereby said grout exhibits a thermal conductivity of greater than 4 W/mK.

17. A method of making a thermally conductive grout for geothermal heat pump systems, comprising the steps of:
Mixing a cementitious base with a thermally conductive additive to make a thermally conductive grout mixture having a thermal conductivity of greater than 4 W/mK; and
Applying said thermally conductive grout mixture to a geothermal heat pump system.

18. The method of claim 17, wherein said thermally conductive additive is graphite.

19. The method of claim 18, wherein said thermally conductive additive natural graphite.

20. The grout of claim 18, wherein said graphite has particles ranging in size from about 10 to about 1000 micrometers.

21. The grout of claim 19, wherein said graphite has particles ranging in size from about 10 to about 1000 micrometers.

22. The grout of claim 18, wherein said graphite has particles ranging in size from about 200 to about 500 micrometers.

23. The grout of claim 19, wherein said graphite has particles ranging in size from about 200 to about 500 micrometers.

24. The grout of claim 17, wherein said thermally conductive additive comprises from about 2 to about 25 percent by weight.

25. The grout of claim 24, wherein said thermally conductive additive comprises from about 5 to about 15 percent by weight.
